(19) United States
(12) Patent Application Publication
(10) Pub. No.: US 2005/0216298 A1
(43) Pub. Date: Sep. 29, 2005

(54) Discounted pre-paid overnight mailers

(76) Inventor: Lance C. Kincaid, Shawnee Mission, KS (US)

Correspondence Address: LITMAN LAW OFFICES, LTD, PO BOX 15035, CRYSTAL CITY STATION, ARLINGTON, VA, 22215, US

(21) Appl. No.: 11/077,227

(22) Filed: Mar. 11, 2005

Related U.S. Application Data
(60) Provisional application No. 60/556,076, filed on Mar. 25, 2004.

(51) Int. Cl. G06F 17/60

(52) U.S. Cl. 705/1

(57) ABSTRACT

The discounted prepaid overnight mailers is a method for marketing discounted prepaid overnight letters or packs. The method involves buying prepaid overnight mailers from a delivery service provider in bulk at a discounted rate, repackaging the letters or packs in packages of at least one letter or pack for the retail market, and reselling the repackaged letters or packs to retail outlets at a unit cost higher than the discounted rate.

### CROSS-REFERENCE TO RELATED APPLICATION

This application claims the benefit of U.S. Provisional Patent Application Ser. No. 60/556,076, filed Mar. 25, 2004.

### BACKGROUND OF THE INVENTION

1. Field of the Invention

The present invention relates to pre-paid mailers, and particularly to a business method of merchandizing flat rate, pre-paid overnight mailers to retail outlets.

2. Description of the Related Art

Overnight delivery service of envelopes and small packages is available from a number of sources, DHL™, UPS™, and FedEx™ being just a few. They are joined by the United States Postal Service with either their Express Mail product or their Priority Mail product if delivery can be stretched to two or more days. Generally, these services charge by weight and destination and therefore require a user to either have an existing account wit the service provider, or to visit an outlet personally where payment can be done in person.

A recent innovation in express delivery marketing is the use of flat rate, pre-paid delivery envelopes, the selling price of which includes the cost of shipping, normally to anywhere within the 48 contiguous United States. These envelopes offer the customer with a convenient means of shipping documents, CD/DVD's, and relatively small items without the necessity of having an existing account with a delivery service. Delivery service providers generally offer their products online and in bulk quantity to avoid the distribution costs to market the items to an infrequent customer who may require only a single mailer. DHL™, for instance, offers their Flight-Ready^{SM} pre-paid overnight mailer in quantities of ten, with no discount for large quantities. Furthermore, one must wait approximately two business days after processing for the Flight-Ready^{SM} envelope to arrive. Similarly the U.S. Postal Service offers pre-paid Priority Mail Flat Rate Envelopes in packages of 5, 10 or 25, available exclusively via the Postal Store web site or by telephone. Again, one must wait for the envelopes to arrive.

Pre-paid envelopes have become popular internationally a well. De Post/La Poste, a Belgian company, provides pre-paid envelopes as a means of simplifying franking, a European term used for the right of sending letters or postal packages free of charge. However, similar to the offerings of their colleagues on this side of the Atlantic, their pre-paid envelopes are not sold singly.

None of the related art, taken either singly or in combination, is seen to describe the instant invention as claimed. Thus a business method merchandising discounted pre-paid overnight mailers, including letters and packs, solving the aforementioned problems is desired.

### SUMMARY OF THE INVENTION

The method of marketing pre-paid overnight mailers, including letters and packs, comprises the steps of buying pre-paid overnight letters or packs from a delivery service provider in bulk at a discounted rate, repackaging the letters or packs in packages of at least one letter or pack for the retail market, and reselling the repackaged letters or packs to retail outlets at a unit cost higher than the discounted bulk rate. Such discounted bulk packages of flat pre-paid mailers offer the consumer a great convenience by increasing their availability.

These and other features of the present invention will become readily apparent upon further review of the following specification and drawings.

### BRIEF DESCRIPTION OF THE DRAWINGS

FIG. 1 is a block diagram of the process by which discounted pre-paid overnight mailers are repackaged according to the present invention.

FIG. 2 is a flowchart showing the steps of a method of marketing pre-paid overnight mailers according to the present invention.

Similar reference characters denote corresponding feature consistently throughout the attached drawings.

### DETAILED DESCRIPTION OF THE PREFERRED EMBODIMENTS

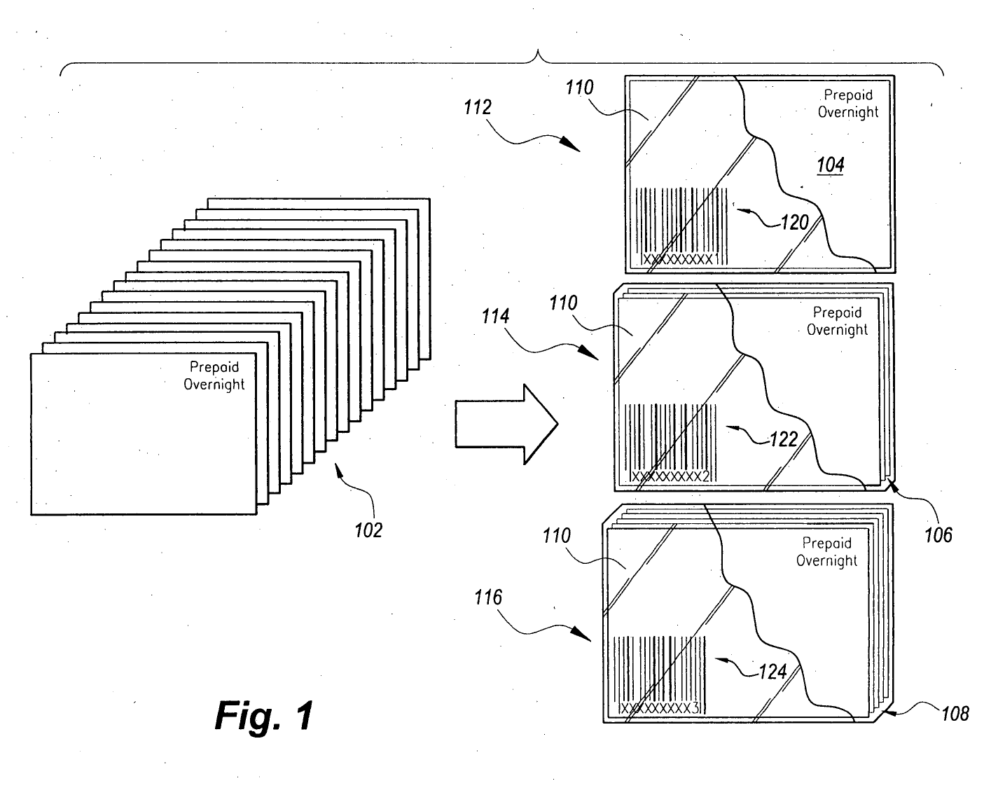

The present invention is a method for marketing pre-paid overnight mailers or delivery envelopes bought at a bulk discount rate, and is best illustrated by the process shown in the block diagram of FIG. 1.

Pre-paid overnight delivery envelopes and “packs” are generally not sold at retail outlets. Typically, one would have an account with a delivery service, such as DHL™ or FedEx™, an one must call in a request for supplies. The present invention offers a new business model by which retail consumers ma conveniently purchase single or small quantity pre-paid overnight delivery envelopes or delivery packs in a retail outlet, thereby providing infrequent users of overnight delivery services an alternative to the second day or longer service provided by the U.S. Postal Service.

As shown in FIG. 1, the company (the “Company”) employing this business model starts the process by purchasing pre-paid overnight delivery envelopes or packs in bulk 102 from a delivery provider such as DHL™. These bulk purchases may be done over the Internet, by telephone or by other ordering means. Typically, the Company must have an account with the delivery service provider in order to buy in bulk and must be authorized to resell the product.

The Company takes these envelopes delivered in bulk and breaks them down into smaller lots of one mailer 104, three mailers 106, or five mailers 108. Not limiting, these smaller lots are subject to change depending upon the most popular packaging arrangement preferred by the retail public. These smaller lots are then shrink wrapped in plastic 110 by methods known in the art of packaging, and a UPC (Universal Product Code) bar code 120, 122, 124 is applied to each package identifying the product type and the quantity therein. Alternatively, an insert having the UPC code and other marketing indicia printed theron may be the first item beneath the clear shrink-wrap. These repackaged pre-paid overnight mailer packages 112, 114, 116 are then boxed and sold to retail outlets that then offer them to the public. The packages may be sold directly from the box or may be presented to the public in a display case specifically designed for the product.

By selling the repackaged mailers at a price higher than the cost of the mailer when purchased at the bulk rate, taking into account the various labor and material costs incurred by the repackaging, the Company may achieves a positive return on investment. Furthermore, the retail public reaps the benefit of having a convenient means of purchasing flat rate, pre-paid overnight mailers previously available only to businesses.

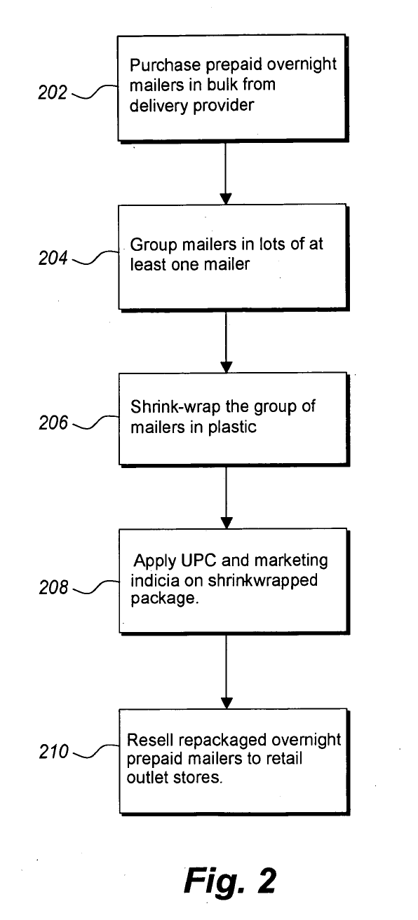

FIG. 2 provides a flow chart summarizing the process an includes the steps of: purchasing the pre-paid mailers in bulk 202; grouping the mailers in smaller lots 204; shrink wrapping the packages 206; applying a UPC code 208; and finally distributing the packages to the retail outlets 210.

It will be understood that the term “mailers” as used herein refers to envelopes, plastic delivery packs or pouches, boxes, or any other shipping container utilized by private or public delivery services.

It is to be understood that the present invention is not limited to the embodiment described above, but encompasses any and all embodiments within the scope of the following claims.

1. A method for marketing discounted pre-paid overnight mailers, comprising the steps of:
buying pre-paid overnight mailers from a delivery service provider in bulk at a discounted rate;
repackaging the mailers in lots of at least one mailer for the retail market; and
reselling the repackaged mailers to retail outlets at a unit cost higher than the discounted rate.

2. The method of marketing pre-paid overnight mailers according to claim 1, further comprising the step of encapsulating the repackaged mailers in shrink wrapped plastic packages.

3. The method of marketing pre-paid overnight mailers according to claim 2, further comprising the step of affixing Universal Price Code and marketing indicia on the shrink wrapped plastic packages.

4. The method of marketing pre-paid overnight mailers according to claim 2, further comprising the step of inserting printed Universal Price Code and marketing indicia within the shrink wrapped plastic packages.

5. A method for marketing discounted pre-paid overnight mailers, comprising the steps of:
buying pre-paid overnight mailers from a delivery service provider in bulk at a discounted rate;
repackaging the mailers in lots of at least one mailer for the retail market;
encapsulating the repackaged mailers in shrink wrapped 8 plastic packages;
affixing Universal Price Code and marketing indicia on the shrink wrapped plastic packages; and
reselling the repackaged mailers to retail outlets at a unit cost higher than the discounted rate.

6. A method for marketing discounted pre-paid overnight mailers, comprising the steps of:
buying pre-paid overnight mailers from a delivery service provider in bulk at a discounted rate;
repackaging the mailers in lots of at least one mailer for the retail market;
encapsulating the repackaged mailers in shrink wrapped plastic packages;
inserting printed Universal Price Code and marketing indicia within the shrink wrapped-plastic packages; and
reselling the repackaged mailers to retail outlets at a unit cost higher than the discounted rate.
